(19) United States
(12) Patent Application Publication
(10) Pub. No.: US 2025/0296045 A1
(43) Pub. Date: Sep. 25, 2025

(54) Adsorption Textile for Adsorbing Carbon Dioxide, System, and Use of a System Of This Type

(71) Applicant: Volkswagen Aktiengesellschaft, Wolfsburg (DE)

(72) Inventors: Christine Schütz, Vordorf (DE); Marc Rüggeberg, Braunschweig (DE)

(73) Assignee: Volkswagen Aktiengesellschaft, Wolfsburg (DE)

(21) Appl. No.: 18/862,415

(22) PCT Filed: Apr. 18, 2023
(86) PCT No.: PCT/EP2023/059993

§ 371 Date: Nov. 1, 2024

(30) Foreign Application Priority Data
May 2, 2022 (DE) 10 2022 110 652.7

(51) Int. Cl. B01D 53/82; B01D 53/62; B01D 53/96; B01J 20/26; B01J 20/28

(52) U.S. Cl. CPC B01D 53/82; B01D 53/62; B01D 53/96; B01J 20/262; B01J 20/28038; B01D 2253/202; B01D 2258/06; B01D 2259/40088

(57) ABSTRACT

The disclosure relates to an adsorption textile for adsorbing CO₂, comprising at least one core layer, at least one thermally conductive layer, which is disposed on the at least one core layer, and at least one adsorber layer, which is disposed on the at least one thermally conductive layer. The at least one adsorber layer is designed to absorb CO₂ from the air and/or to desorb the same. The disclosure also relates to a method for manufacturing a textile of this kind, to a system comprising a textile of this type, and to the use of said system. The disclosure allows CO₂ to be extracted ecologically and efficiently.

### CROSS-REFERENCE TO RELATED APPLICATIONS

This application claims priority to German Patent Application No. DE 10 2022 110 652.7, filed on May 2, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to an adsorption textile for adsorbing carbon dioxide (CO₂), comprising a core layer, a thermally conductive layer, and an adsorber layer, to the manufacture of a textile of this type, to a system comprising a textile of this type, and to the use of the textile for extracting CO₂.

There is an urgent need to slow down global climate change caused by greenhouse gas emissions. Above all, the increase in atmospheric CO₂ values must be sustainably prevented. In addition to the prevention and reduction of CO₂, technologies for adsorbing CO₂ from the ambient air are known. In particular, “direct air capture” (DAC) is suitable for reducing the proportion of CO₂ in the atmospheric air by means of “negative carbon emissions”. The development of suitable adsorption materials is intended to allow for efficient carbon capture that makes sense in energy terms.

A challenge in this regard is the development of efficient adsorption materials that have a high CO₂ adsorption capacity and that require little energy for the desorption. In particular, thermal properties of the adsorption materials constitute an effective point of leverage for applying DAC technologies on an industrial scale.

Classic adsorption materials that, for example, comprise metal-organic frameworks (MOFs), zeolites, amino-functionalized materials, and polymer-based adsorbers.

### SUMMARY

A need exists to provide materials that are specifically tailored to removing CO₂ from the atmospheric air.

The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of an example DAC method for removing CO₂ from the atmospheric air;

FIG. 2 shows an adsorption textile according to one embodiment;

FIG. 3 shows an adsorption textile according to another embodiment;

FIG. 4 is a block diagram for an example method for manufacturing an adsorption textile according to the teachings herein;

FIG. 5 shows a system comprising an adsorption textile according to an embodiment;

FIG. 6 shows a system comprising an adsorption textile according to an embodiment;

FIG. 7 is a block diagram for an example use of the adsorption textile; and

FIG. 8 is a representation of the example use of a system having an adsorption textile.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

According to some embodiments, an adsorption textile for adsorbing carbon dioxide is described, comprising: at least one core layer; at least one thermally conductive layer, which is disposed on the at least one core layer; and at least one adsorber layer, which is disposed on the at least one thermally conductive layer, wherein the at least one adsorber layer is designed to adsorb carbon dioxide from the air and/or to desorb the same.

In particular, the coating shortens the cooling and heating phases, reducing energy consumption due to its good thermal conductivity compared to conventional solutions from the prior art.

In the context of the teachings herein, a “textile” is for example a flexible material that is manufactured by creating an interlocking bundle of yarns and threads which are produced by spinning raw fibers, either from natural or synthetic sources, into long and twisted lengths. Textiles are then formed by weaving, knitting, crocheting, knotting, tatting, felting, gluing, or braiding these threads.

In the context of the teachings herein, the core layer serves as a substrate for the adsorption coating. However, non-metallic textile materials have insufficient thermal conductivity, meaning that a lot more time and energy are required for the heating and cooling. This in turn has a negative effect on the efficiency of the adsorption materials. Therefore, according to some embodiments, the adsorption textile comprises a thermally conductive coating.

Classic adsorption materials, for example metal-organic frameworks (MOFs), zeolites, and polymers, have a relatively low thermal conductivity. As a result of this, a lot more time and energy are required for the heating and cooling. This in turn has a negative effect on the efficiency of the adsorption materials, particularly in the case of direct air capture technology (DAC technology).

In contrast, the amino-functionalized adsorption means described herein provide an efficient possibility for combining a high adsorption capacity with economic benefits. In connection with the teachings herein, it has been found that this is possible, in particular, by adapting the thermal conductivity. In order to make the removal of carbon dioxide from the air energy-efficient, it is important to select the adsorption materials such that the energy for the desorption and associated heating and cooling phase is reduced to a minimum. The thermal properties of the adsorption materials also play a role here, and this is precisely what may be achieved by the teachings herein.

In some embodiments, the adsorption textile is described, wherein the at least one core layer comprises a fiber material.

In some embodiments, the adsorption textile is described, wherein the at least one core layer comprises glass fiber.

Glass fiber has approximately comparable mechanical properties to other fibers, such as polymers and carbon fiber. In some embodiments, the glass fiber may be used in composite materials. In this case, it is cheaper and much less brittle. The high modulus of elasticity is utilized in order to improve the mechanical properties of plastics. In particular, as some possible embodiments, a combination of glass fibers and plastics fibers is described in order to optimize the substrate properties of the core layer.

The benefit of using glass fibers is that they are ageing-resistant, weatherproof, chemically resistant, and incombustible.

In some embodiments, the adsorption textile is described, wherein the at least one core layer comprises plastics fiber.

For example, polyester fiber is particularly used here. However, a mixture of artificial and natural fibers can also be used, for example cotton blends or 80% cotton and 20% polyester.

One possibility for generating a large surface area and thus good CO₂ absorption capacity is to use fibers as the substrate for the adsorption coating. However, both glass fibers and plastics fibers exhibit insufficient thermal conductivity. As a result of this, a lot more time and energy are required for the heating and cooling. This in turn has a negative effect on the efficiency of the adsorption materials. Therefore, the embodiments described herein, which have a fiber-containing core layer as well as a thermally conductive coating, are particularly beneficial.

In some embodiments, the adsorption textile is described, wherein the at least one core layer is designed as a woven fabric, laid scrim, nonwoven fabric, or knitted fabric.

In the context of the teachings herein, “woven fabric” refers to a textile which is produced by means of weaving. Woven materials are produced, for example, using a loom and consist of numerous fibers that are woven in warp and weft. A woven material is, in this case, a material that is produced by intertwining two or more threads at substantially a right angle to one another. In the context of the teachings herein, woven materials may consist of both natural and synthetic fibers and are often produced from a mixture of the two.

In some embodiments, the adsorption textile is described, wherein the adsorption textile is permeable to gas. In some embodiments, the adsorption textile is described, wherein the adsorption textile is permeable to air.

The fibrous structure of the adsorption textile beneficially makes it possible for the adsorption textile to be permeable to gas. This makes it possible, after admitting ambient air, to charge the adsorption textile with carbon dioxide while the air flows through the textile.

In some embodiments, the adsorber layer comprises at least one amine as the adsorber material. For example, polyethyleneimine or corresponding derivatives may be used. These are particularly well suited as a functionalized coating, since there does not necessarily have to be a covalent bond due to the entanglement of the polymer.

In some embodiments, the adsorption textile is described, wherein the adsorption textile comprises a heating-cooling element.

In some embodiments, the adsorption textile is described, wherein the adsorption textile comprises a heating-cooling element, wherein the heating-cooling element is connected to the thermally conductive coating, wherein the textile does not comprise an adsorber layer at this location. In other words, the textile is free from an adsorber layer at this location.

This has the benefit that the adsorption textile can be disposed at least partially outside the chamber, wherein the at least one heating-cooling element, in particular the Peltier element, may be disposed outside the chamber. This allows for selective and efficient heating and cooling, as explained below.

For example, the core layer is designed as a continuous fiber, wherein the fiber comprises interruptions in order to integrate the heating-cooling element in the textile. For example, a continuous process is represented by various fiber portions.

In some embodiments, the adsorption textile is described, wherein the heating-cooling element is designed as a Peltier element.

Peltier elements are thermoelectric heat pumps. In other words, by supplying electrical energy, heat can be transported against its natural gradient. This makes it possible to cool or to heat using these components, depending on the application scenario. This behavior is defined by the direction of flow. In the process, heat is extracted from the environment on one side and transported to the other side of the element, where it is emitted via the surface.

Here, the temperature difference may for example be at least 20 K, or for example at least 40 K, or for example at least 70 K, or for example at least 100 K. For example, the element is designed in multiple stages. Peltier elements are also referred to as thermoelectric coolers.

In some embodiments, a Peltier element is used, since it can for example be used where cooling with a small temperature difference, precise regulation, and dynamic behavior is required. This is provided in the present case.

For example, Peltier elements are used, since they can be integrated well into the textile.

According to some embodiments, a method for manufacturing an adsorption textile is described, wherein the method comprises the steps of:
provision of at least one core layer;
provision of at least one thermally conductive layer on the at least one core layer;
provision of at least one adsorber layer on the at least one thermally conductive layer.

In some embodiments, the method is described, wherein the provision of the at least one thermally conductive layer already takes place as one step with the provision of the core layer by means of fiber spinning.

The methods for generating chemical fibers by means of fiber spinning can be categorized as follows: solution spinning methods, melt spinning methods, and dispersion spinning methods. The latter are also referred to as matrix spinning methods. Solution spinning is a method for spinning infusible polymers, which are dissolved for this purpose. Two methods are distinguished here: wet spinning and dry spinning methods.

In the case of solution spinning, the spinning material is produced by dissolving the polymer or a derivate of said polymer in a suitable solvent. This spinning material is pressed through holes of a spinneret. In the wet spinning method, the resulting spinning solution jets are solidified into filaments by transferring the solvent to the spin bath. The solution usually contains between 5 and 40 wt. %, especially 20 to 25 wt. % solid material. The solvent is recovered during the spinning.

In some embodiments, the method is described, wherein the provision of the at least one thermally conductive layer takes place by means of thermal evaporation with a thermally conductive material on the core layer.

In some embodiments, a system is described, which comprises: a chamber, as well as an adsorption textile, wherein the adsorption textile is disposed at least partially inside the chamber.

In some embodiments, the system is described, wherein the adsorption textile is disposed at least partially outside the chamber and the adsorption textile comprises at least a heating-cooling element, in particular a Peltier element, which is disposed outside the chamber.

In some embodiments, the use of the system is described, comprising the steps of: admission of ambient air in order to charge the adsorption textile with carbon dioxide, and discharge of carbon dioxide-depleted air.

In some embodiments, the system is described, wherein the use of the system further comprises the step of regeneration of the adsorption textile, wherein the carbon dioxide bound to the adsorption textile is released therefrom.

In some embodiments, a method for removing CO₂ from the air using the adsorption means is described, wherein the adsorption means is brought into contact with atmospheric air in an adsorption step.

In some embodiments, the method for removing CO₂ from the air using the adsorption means is described, wherein the CO₂ is released in a desorption step.

In some embodiments, the method for removing CO₂ from the air using the adsorption means is described, wherein the method is designed as a DAC method.

The extracted CO₂ can then be reused. To improve the overall CO₂ balance of vehicles, the use of renewable raw materials is an effective point of leverage. In this context, sustainable polymer solutions are increasingly important in the automotive industry based on the life cycle analysis of motor vehicles.

The CO₂ extracted by means of DAC methods using the functionalized adsorption material can be used, in particular, for synthesis purposes. Thermoplastic polymers based on bound CO₂, in addition to being easy to process in forming processes, also have a property profile that is specific to the relevant application and have a negative CO₂ balance throughout the product life cycle.

Some embodiments of the teachings herein result from the remaining features mentioned in the dependent claims.

The be various embodiments mentioned in this application can combined with one another, unless otherwise indicated in individual cases.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

FIG. 1 is a schematic representation of a DAC method for removing CO₂ from the atmospheric air.

In this case, the conventional DAC device is designed as a single unit comprising an adsorption means. The adsorption 10 and desorption or rather regeneration 20 may take place one after the other.

During the adsorption 10, in the first step, the system is opened and atmospheric air flows in without any further aids or with the aid of blowers. At ambient temperature, CO₂ chemically binds and the CO₂-depleted air exits the system 11. This step is completed when the adsorption means is completely saturated with CO₂. In the next step, the fans are switched off, the inlet valve is closed, and the remaining air is led out either by means of suction by means of a pressure drop 4 or by introducing steam from the system.

Subsequently, the regeneration 20 takes place, in that the system is heated 3 to a particular temperature. This effectively releases the CO₂. The released CO₂ is collected and transported out of the system for cleaning, compression, or utilization. To start another cycle, the system should be cooled down to ambient conditions.

Electrical energy is fed in 2, 5 for operating the plant both during the adsorption 10 and during the desorption 20.

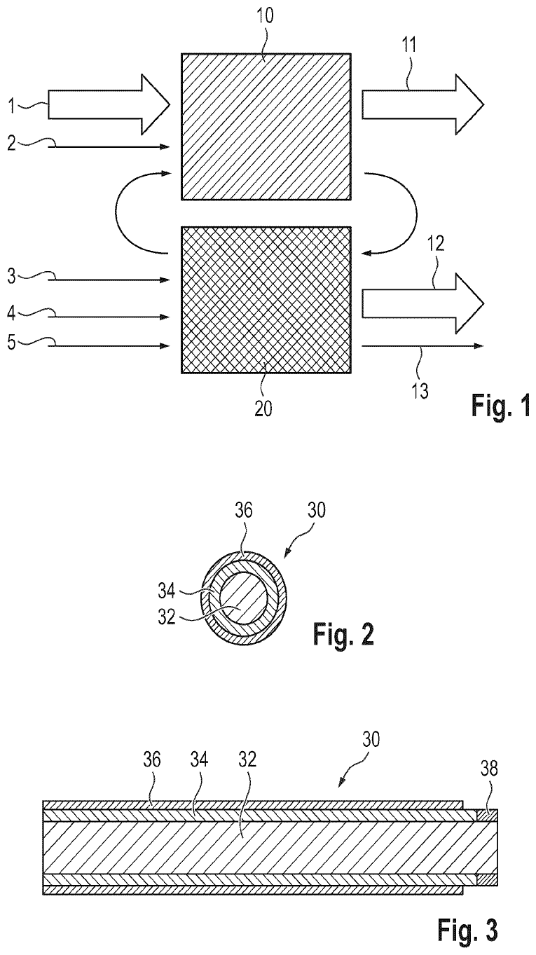

FIG. 2 shows an adsorption textile according to one embodiment. The adsorption textile 30 is suitable for adsorbing carbon dioxide and comprises a core layer 32. This core layer 32 is used as a substrate layer here.

Furthermore, at least one thermally conductive layer 34 is disposed on the above-mentioned core layer 32. At least one adsorber layer 36 is disposed on the at least one thermally conductive layer 34. Said adsorber layer 36 is designed to adsorb carbon dioxide from the air and to desorb the same again during a later regeneration cycle. As a result, CO₂ previously absorbed, for example, within the scope of a DAC method can be obtained and thus extracted in an ecologically beneficial manner.

Classic adsorption materials that comprise, for example, metal-organic frameworks (MOFs), zeolites, amino-functionalized materials, and polymer-based adsorbers can be used for the adsorber layer. However, polyethyleneimines or corresponding derivates are for example used. These are particularly well suited as a functionalized coating, since there does not necessarily have to be a covalent bond due to the entanglement of the polymer.

The adsorption textile 30 is designed as a woven fabric, laid scrim, nonwoven fabric, or knitted fabric and comprises a fiber-containing material. For example, glass fiber and plastics fiber, in particular polyester fiber, is used here. In the context of the teachings herein, “woven fabric” refers to a textile which is produced by means of weaving. Woven materials are produced, for example, using a loom and consist of numerous fibers that are woven in warp and weft. The fibrous structure of the adsorption textile makes it possible for the adsorption textile 30 to be permeable to gas. In particular, the textile 30 is permeable to air. This makes it possible, after admitting ambient air, to charge the adsorption textile 30 with carbon dioxide while the air flows through the textile 30. Finally, the carbon dioxide-depleted air can be discharged again through a suitable outlet. This, in turn, is a prerequisite for suitable regeneration of the adsorption textile, wherein the carbon dioxide bound to the adsorption textile 30 is released therefrom.

FIG. 3 shows an adsorption textile 30 according to another embodiment. The adsorption textile 30 according to this embodiment comprises a heating-cooling element 38. The heating-cooling element 38 is, in particular, a Peltier element, i.e. a thermoelectric element. The textile does not comprise an adsorber layer at this location. In other words, the textile is free from an adsorber layer at this location, wherein this has the benefit that the adsorption textile can be disposed at least partially outside the chamber, and therefore the at least one heating-cooling element, in particular the Peltier element, may also be disposed outside the chamber.

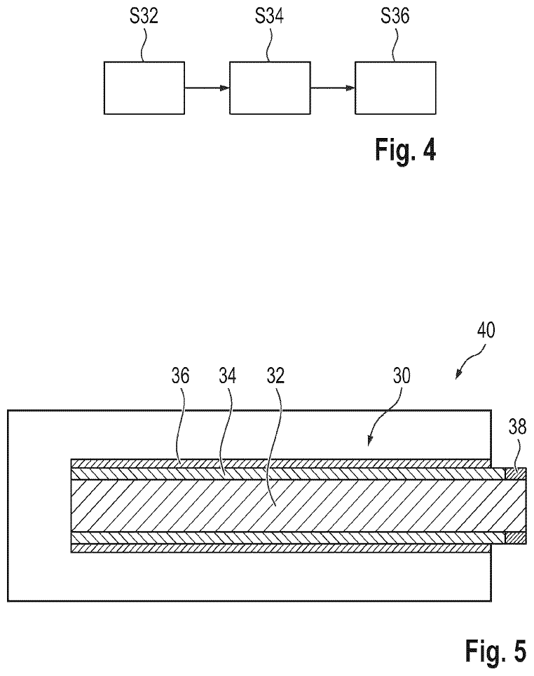

FIG. 4 is a block diagram for a method for manufacturing an adsorption textile 30. According to this method for manufacturing an adsorption textile 30, provision S32 of the at least one core layer 32 takes place first. Following on from this is the provision S34 of the at least one thermally conductive layer 34 on the at least one core layer 32. As a further step, provision S36 of the at least one adsorber layer 36 on the at least one thermally conductive layer 34 takes place. The provision S34 of the at least one thermally conductive layer 34 may take place as one step with the provision S32 of the core layer 32 by means of fiber spinning.

However, it is for example the provision of the at least one thermally conductive layer 34 to take place by means of thermal evaporation with a thermally conductive material on the core layer 32. The fiber is coated with thermally conductive material by vapor deposition, wherein, in particular, precious metals, copper, silver, gold, electroplating, alloys, graphite, and/or DLC can be used. The use of fibers as the substrate for the adsorption coating produces a large surface area, but the insufficient thermal conductivity of both glass fibers and plastics fibers has a detrimental effect. Time- and energy-intensive heating and cooling hampers the efficiency of the adsorption process. Therefore, the teachings herein, which combines the fiber-containing core layer with a thermally conducive coating, is particularly beneficial.

FIG. 5 shows a system comprising an adsorption textile 30 according to one embodiment. The system comprises a chamber 40 and an adsorption textile 30, wherein the adsorption textile 30 is disposed only partially inside the chamber 40. The adsorption textile 30 is disposed at least partially outside the chamber 40. Thus, the adsorption textile 30 may comprise at least one heating-cooling element 38, in particular a Peltier element, which is disposed outside the chamber 40. This allows for selective and efficient heating and cooling, wherein, in particular, the thermally conductive coating can be utilized in a thermally efficient manner to introduce thermal energy into the chamber and dissipate the same therefrom again.

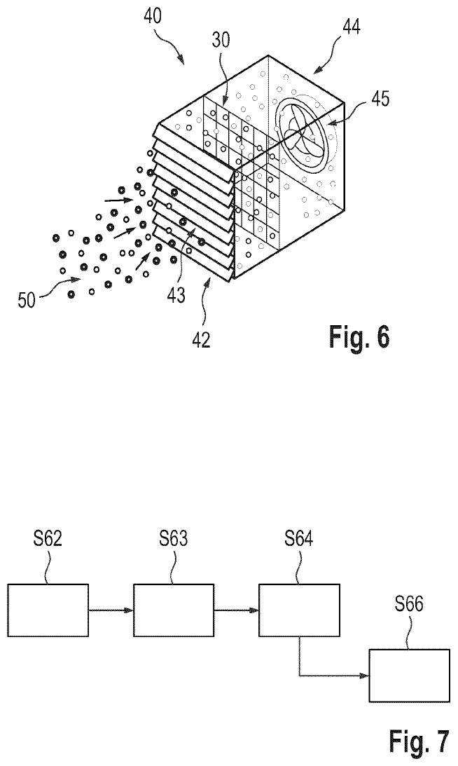

FIG. 6 shows a system comprising an adsorption textile 30 according to another embodiment. In this case, the system comprises the chamber 40. The chamber 40 comprises a first side 42 having an inlet 43. Furthermore, the chamber 40 comprises a second side 44 having an outlet 45. Ambient air 50 can be introduced into the chamber through the inlet 43 of the first side 42 in order to bind to the adsorption textile 30.

FIG. 7 is a block diagram for a use of the adsorption textile 30. During use of the system, firstly ambient air is admitted S62 in order to charge the adsorption textile 30 with carbon dioxide S63. Carbon dioxide-depleted air is discharged from the system via the outlet. In another step, the regeneration S66 of the adsorption textile 30 takes place, wherein the carbon dioxide bound to the adsorption textile 30 is released therefrom. On account of the special structure of the adsorption textile 30, the desorption cycles can be selected so as to be very short in the range of minutes, wherein only the surface is heated and the fiber is not yet heated. This is particularly favorable from an energy perspective, since the heating-cooling phases can be reduced as a result.

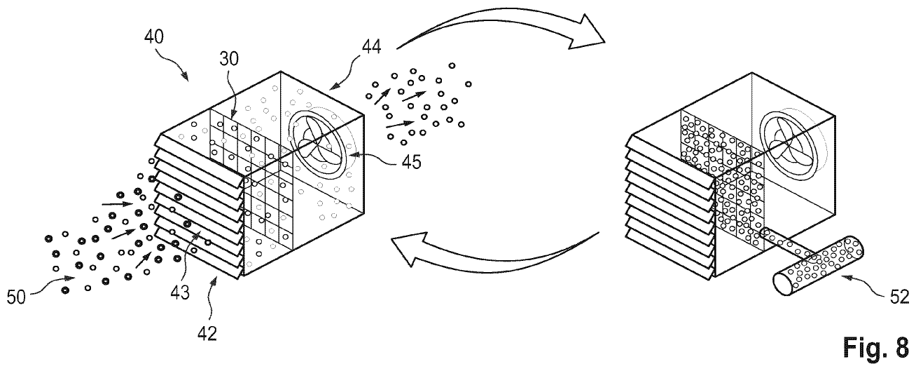

FIG. 8 is a representation of the use of a system having an adsorption textile 30. During use of the system, firstly ambient air is admitted in order to charge the adsorption textile 30 with carbon dioxide. For this purpose, the chamber 40 comprises a first side 42 having an inlet 43, wherein ambient air 50 is introduced into the chamber through the inlet 43 of the first side 42 in order to bind to the adsorption textile 30. The fibrous structure of the adsorption textile 30 makes it possible for the adsorption textile 30 to be permeable to gas. In particular, the textile 30 is permeable to air. This makes it possible, after admitting ambient air, to charge the adsorption textile 30 with carbon dioxide while the air flows through the textile 30. Furthermore, the chamber 40 comprises a second side 44 having an outlet 45. Carbon dioxide-depleted air is discharged from the system via the outlet 45. In another step, the regeneration of the adsorption textile 30 takes place, wherein the carbon dioxide bound to the adsorption textile 30 is released therefrom and collected via a CO₂ outlet 52.

### LIST OF REFERENCE NUMERALS

1 Atmospheric air
2 Input of electricity for adsorption
3 Input of heat
4 Pressure drop
5 Input of electricity for regeneration
10 Adsorption phase
11 Output of CO₂-depleted air
12 Output of pure CO₂
13 Output of water
20 Regeneration phase
30 Adsorption textile
32 Core layer
34 Thermally conductive layer
36 Adsorber layer
38 Heating-cooling element
40 Chamber
42 First side
43 Inlet
44 Second side
45 Outlet
50 Gas
S22 Provision of at least one core layer
S34 Provision of at least one thermally conductive layer 1
S36 Provision of at least one adsorber layer
S62 Admission of air
S63 Charging of the adsorption textile
S64 Discharge of air
S66 Discharge of CO₂ and regeneration

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-12. (canceled)

13. An adsorption textile for adsorbing carbon dioxide, comprising: at least one core layer; at least one thermally conductive layer, which is disposed on the at least one core layer; and at least one adsorber layer, which is disposed on the at least one thermally conductive layer, wherein the at least one adsorber layer is configured to absorb carbon dioxide from the air and/or to desorb the same.

14. The adsorption textile of claim 13, wherein the at least one core layer is configured as a woven fabric, laid scrim, nonwoven fabric, or knitted fabric.

15. The adsorption textile of claim 13, wherein the at least one core layer comprises one or more of glass fiber, plastics fiber and polyester fiber.

16. The adsorption textile of claim 13, wherein the adsorption textile is permeable to one or more of gas and air.

17. The adsorption textile of claim 13, wherein the adsorption textile comprises one or more of a heating-cooling element and a Peltier element.

18. A method for manufacturing an adsorption textile of claim 13, wherein the method comprises:
provision of at least one core layer;
provision of at least one thermally conductive layer on the at least one core layer; and
provision of at least one adsorber layer on the at least one thermally conductive layer.

19. The method of claim 18, wherein the provision of the at least one thermally conductive layer takes place together with the provision of the core layer using fiber spinning.

20. The method of claim 18, wherein the provision of the at least one thermally conductive layer takes place by thermal evaporation with a thermally conductive material on the core layer.

21. A system comprising a chamber as well as an adsorption textile, wherein
the adsorption textile is disposed at least partially inside the chamber; and wherein
the adsorption textile comprises: at least one core layer; at least one thermally conductive layer, which is disposed on the at least one core layer; and at least one adsorber layer, which is disposed on the at least one thermally conductive layer, wherein the at least one adsorber layer is configured to absorb carbon dioxide from the air and/or to desorb the same.

22. The system of claim 21, wherein the adsorption textile is disposed at least partially outside the chamber; and the adsorption textile comprises one or more of a heating-cooling element and a Peltier element, which is disposed outside the chamber.

23. A method of using the system of claim 21, comprising:
admission of ambient air in order to charge the adsorption textile with carbon dioxide; and
discharge of carbon dioxide-depleted air.

24. The method of claim 23, further comprising:
regeneration of the adsorption textile, wherein the carbon dioxide bound to the adsorption textile is released therefrom.

25. The system of claim 21, wherein the at least one core layer is configured as a woven fabric, laid scrim, nonwoven fabric, or knitted fabric.

26. The system of claim 21, wherein the at least one core layer comprises one or more of glass fiber, plastics fiber and polyester fiber.

27. The system of claim 21, wherein the adsorption textile is permeable to one or more of gas and air.

28. The system of claim 21, wherein the adsorption textile comprises one or more of a heating-cooling element and a Peltier element.

29. The adsorption textile of claim 14, wherein the at least one core layer comprises one or more of glass fiber, plastics fiber and polyester fiber.

30. The adsorption textile of claim 14, wherein the adsorption textile is permeable to one or more of gas and air.

31. The adsorption textile of claim 15, wherein the adsorption textile is permeable to one or more of gas and air.

32. The adsorption textile of claim 14, wherein the adsorption textile comprises one or more of a heating-cooling element and a Peltier element.
